(19) United States
(12) Patent Application Publication
(10) Pub. No.: US 2002/0091570 A1
(43) Pub. Date: Jul. 11, 2002

(54) Electronic mail advertisement system, method, and program storage medium

(76) Inventor: Hiroaki Sakagawa, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/994,864

(22) Filed: Nov. 28, 2001

(30) Foreign Application Priority Data
Dec. 1, 2000 (JP) 2000-371487

(51) Int. Cl. G06F 17/60; G06F 15/173

(52) U.S. Cl. 705/14; 709/238

(57) ABSTRACT

A system is provided in which a person who has accessed an advertisement can be identified on the server side. In a system that provides a service which reduces a charge for the user who has accessed an advertisement added to a received electronic mail, the server on the network adds address information including a server address, identification information and advertisement address to the mail when it sends the mail to the mail recipient.

### BACKGROUND OF THE INVENTION

The present invention relates to an electronic mail advertisement system to add advertising information to a mail before sending it.

Technologies that provide user terminals with advertisements via network include those disclosed in JP-A-2000-215122 and JP-A-10-290443. JP-A-2000-215122 describes a technique in which attribute data of a sender is attached to electronic mail data before being dispatched and a transit equipment adds to the mail advertisement data and other information pertinent to the attribute and forwards it to the terminal of a recipient.

It is also described in the above specification that providing the advertisement data in the form of banner advertisement data enhances a possibility of being able to obtain more detailed content of advertisement with a simple operation on the terminal. JP-A-10-290443 describes a technique which, as a method of controlling a video-on-demand system to add an advertisement video to a content entity, involves embedding authentication data for the added advertisement video in the content entity by digital watermarking, sending it to a contracted user terminal and, during the playback of the forwarded content entity on the user terminal, extracting the authentication data for the advertisement video, comparing the extracted authentication data with advertisement video authentication data registered in advance by the contracted user and, based on the result of comparison, performing the playback or charging of the content.

JP-A-9-114755 describes an information charging system which outputs an advertisement when information is accessed to cover a part of the price of the information with an advertisement revenue, thereby reducing the price of information for the user and promoting wider use of digital information.

Where a server on the network attaches an address of an advertisement to an electronic mail before dispatching the mail and a recipient accesses the address for the advertisement, the server may not be able to check whether or not the recipient has accessed the advertisement. This poses a problem that the user, though he or she made an access to that advertisement, cannot be provided with further services.

### SUMMARY OF THE INVENTION

JP-A-2000-215122, JP-A-10-290443 and JP-A-9-114755 cited above do not disclose a technique which checks if the mail recipient has accessed the advertisement, identifies the user accessing the advertisement and provides a further service to the user.

An object of the present invention is to provide a system which reduces the mail service charge for the user who has accessed the advertisement.

A means for realizing the above objective is an arrangement in which the server on the network, when forwarding a mail to the mail recipient, adds address information including a server address, identification information and advertisement address to the mail. With this arrangement, whenever the mail recipient accesses the advertisement, that access is routed through the server which, based on the identification information, can determine who has made an access to the advertisement.

Another means for realizing the above objective is an arrangement in which, when the server for providing an advertisement receives information for identifying the advertiser terminal and identification information for identifying the user, the advertiser pays a certain amount of money into an account of the user. This arrangement helps increase the number of users who will refer to the advertisement provided by the advertiser.

### BRIEF DESCRIPTION OF THE DRAWINGS

FIG. 1 is a schematic diagram showing an overall configuration of a system.

FIG. 2 is a block diagram showing a configuration of an advertisement insertion server.

FIG. 3 is a flow chart showing a flow of processing performed by an advertisement insertion unit.

FIG. 4 is a flow chart showing advertisement insertion processing.

FIG. 5 is a flow chart showing a flow of processing performed by a charging processing unit.

FIG. 6 illustrates a structure of an advertiser information database.

FIG. 7 illustrates a structure of a user access database.

FIG. 8 illustrates a structure of a users' personal information database.

FIG. 9 illustrates an example of how advertisements are inserted into an electronic mail.

FIG. 10 illustrates another example of how advertisements are inserted into an electronic mail.

FIG. 11 illustrates an example of an inserted advertisement (when information is accessed on the Web).

FIG. 12 illustrates an example of an inserted advertisement (in the case of cellular phone).

FIG. 13 illustrates a structure of an advertiser database.

FIG. 14 illustrates an operation of the entire system.

FIG. 15 illustrates an operation of the entire system.

FIG. 16 illustrates an example order form on a display.

FIG. 17 illustrates an example screen requesting an advertisement.

FIG. 18 illustrates an operation of an entire system according to another embodiment.

FIG. 19 is a flow chart showing a charge calculation according to a further embodiment.

FIG. 20 is a flow chart showing a charge calculation according to a further embodiment.

### DESCRIPTION OF THE EMBODIMENTS

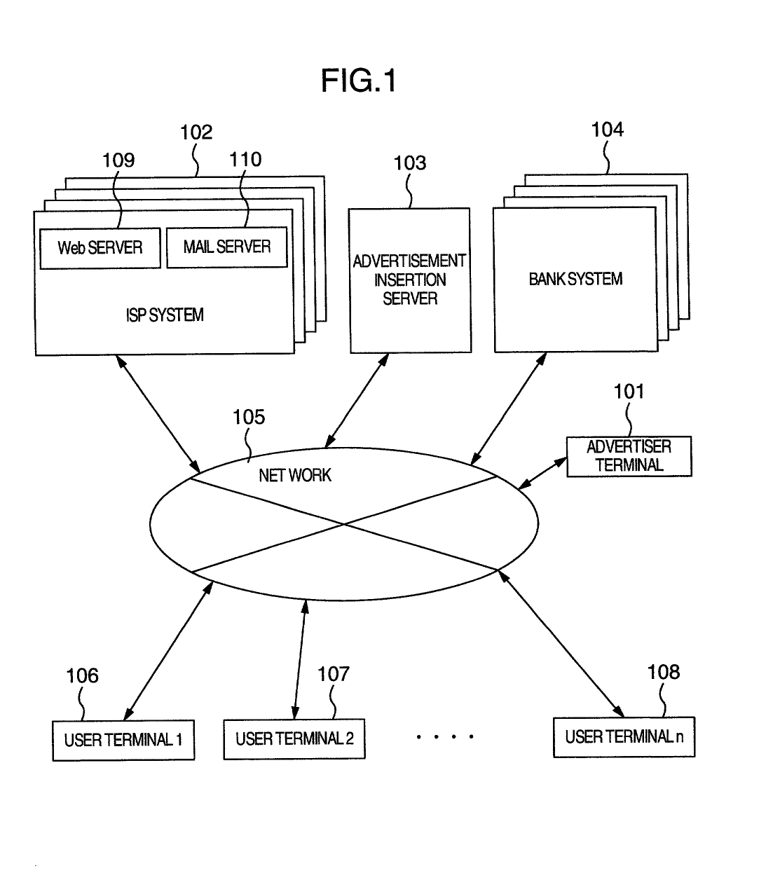

FIG. 1 shows an overall configuration of the system using communication networks including the Internet. Constitutional elements of the system will be described in the following.

An advertiser terminal 101 requests an advertisement insertion server 103 to insert an advertisement in users' electronic mails.

The advertisement insertion server 103 receives advertisement related information from the advertiser terminal 101 and stores and manages the advertisement related information. The advertisement related information here signifies a name of advertiser, a category of advertisement, a content of advertisement, an address of advertiser, URL by which to access the advertisement, etc.

The advertisement insertion server 103 receives user related information from user terminals 106-108 and stores and manages the user related information. Here, the user related information includes names of users, user identifiers, mail addresses, hobbies and tastes of users, bank names, bank's branch names and account numbers used by users for payment, terminals used (category and type of user terminals), etc.

The information that the advertisement insertion server 103 receives may be supplied from other than the advertiser terminal 101 or the user terminals 106-108. For example, an ISP (Internet Service Provider) system 102 may hold the user related information and send it to the advertisement insertion server 103.

The users on the user terminals 106-108 access the ISP system 102 via the communication network 105 for sending and receiving mails. The ISP system 102 has a Web server 109 and a mail server 110.

A bank system 104 performs such operations as reducing an amount charged to the user who has accessed advertisements, paying the service charge incurred from the use of the ISP system 102 and paying the service charge incurred from the use of the communication network. The amount to be returned to the user is determined based on the information in the database held in the advertisement insertion server 103.

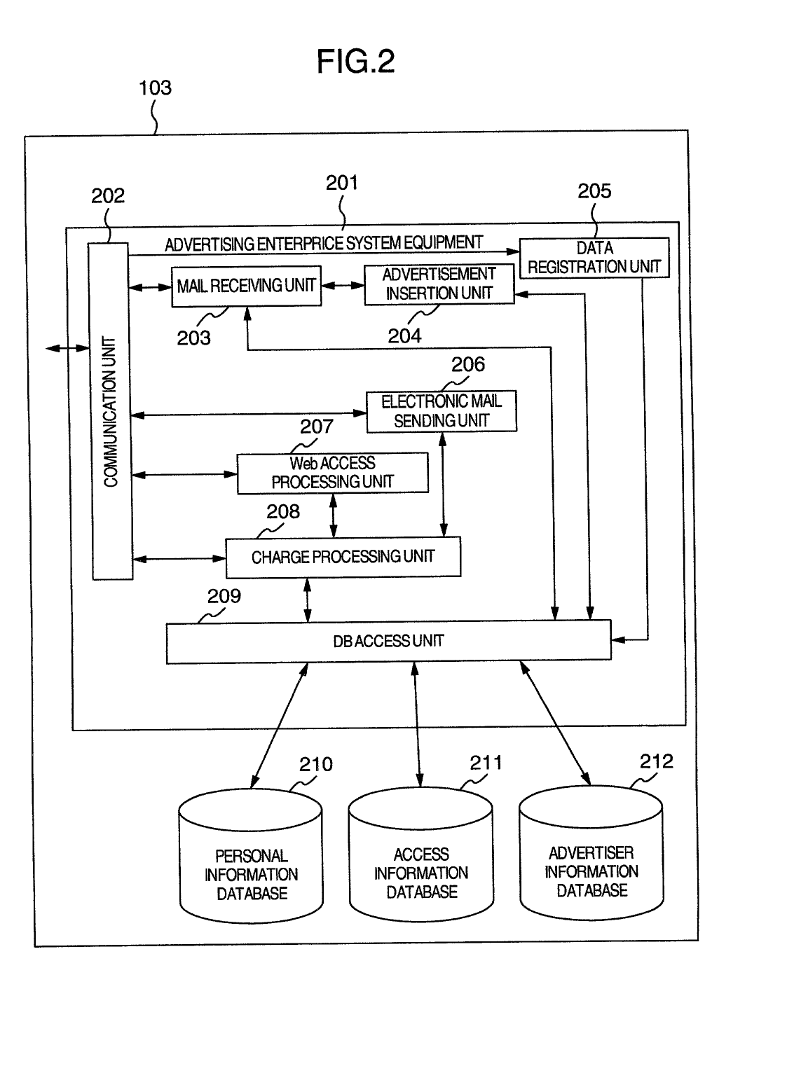

The function of the advertisement insertion server 103 and the database held in the advertisement insertion server 103 are shown in FIG. 2.

FIG. 2 is a functional block diagram showing the configuration of the advertisement insertion server 103.

An advertisement insertion server equipment 201 will be described as follows.

The advertisement insertion server equipment 201 has a communication unit 202 for exchanging various data with the communication network 105, a mail receiving unit 203 for receiving electronic mails, an advertisement insertion unit 204 for inserting advertisements into electronic mails, a data registration unit 205 for registering advertisement information from the advertiser terminal 101 and for registering personal information from the user terminal 106, an electronic mail sending unit 206 for transferring an electronic mail from the user terminal 106 to the mail server 110 and checking if the mail requires the advertisements, a Web access processing unit 207 for analyzing a Web access the user made, a charge processing unit 208 for calculating and reducing the amount charged to the electronic mail user according to the length of time and frequency that the user accesses the advertisements, and a database access unit 209 for making appropriate database accesses according to requests from various processing units.

The above is the main configuration of the advertisement insertion server 201.

Next, explanations will be given as to databases 210-212 connected to the advertisement insertion server 201.

The personal information database 210 stores registered information on hobbies and others of the user, and the access information database 211 stores amounts to be refunded by each advertiser whose advertisements were accessed by the user. The advertiser information database 212 stores registered advertisement information to be inserted into electronic mails.

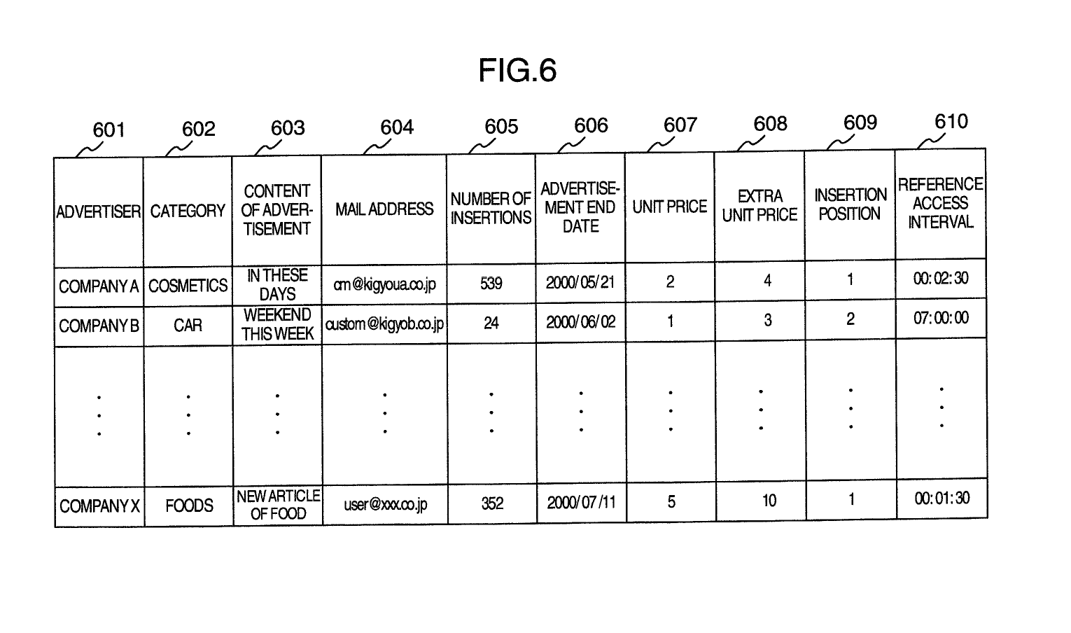

The configuration of the advertiser information database 212 is shown in FIG. 6. The advertiser information database 212 is an aggregate of records each consisting of advertiser name 601, category of advertisement content 602, advertisement content 603, electronic mail address 604, number of insertions 605, advertisement end date 606, unit price 607 for each access, extra unit price 608, insertion position 609, and reference access interval 610.

The advertiser name 601 represents the name of an advertiser requesting the insertion of an advertisement and has a role of an ID of the advertiser that is used in internal processing. Rather than using the advertiser name as an ID, other methods may be used to add an ID (identifier). For example, it is possible to allocate numbers to the advertiser names in the order in which they are stored in the database and use those numbers as identifiers.

The category of advertisement content 602 represents the kind of goods requested for advertisement by the advertiser. For example, when the product is a lipstick, the category is cosmetics. If the advertisement introduces a book or magazine, the category is a book. The category 602 is matched against the hobby/taste 803 in the personal information database 210 described later, and the advertisement whose category matches the hobby/taste 803 of a user will be inserted into the electronic mails to the user. Such a match/similarity check function may be provided to the advertisement insertion unit 204.

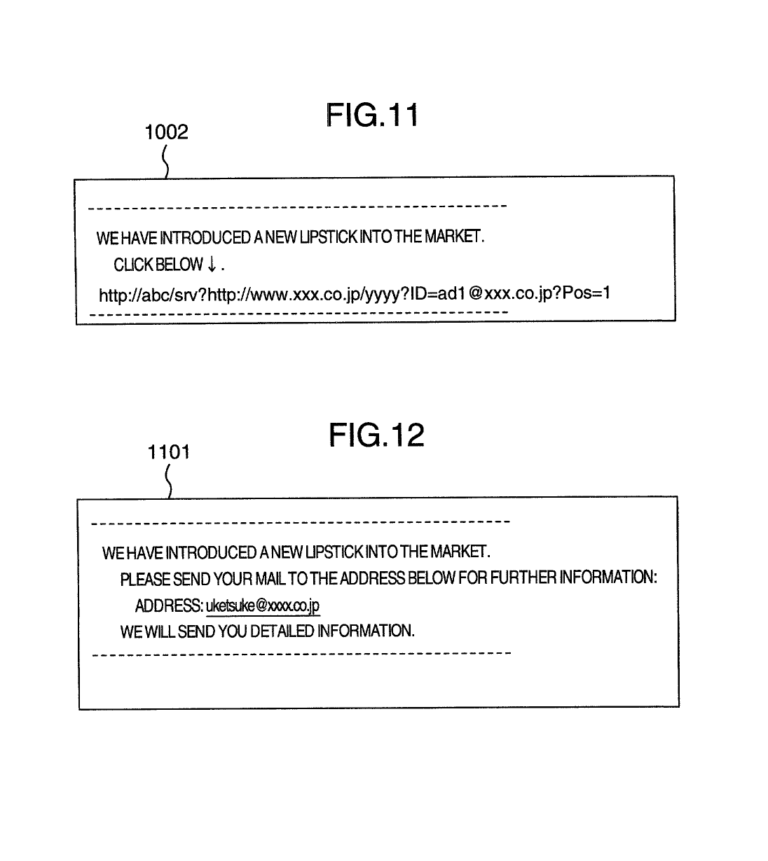

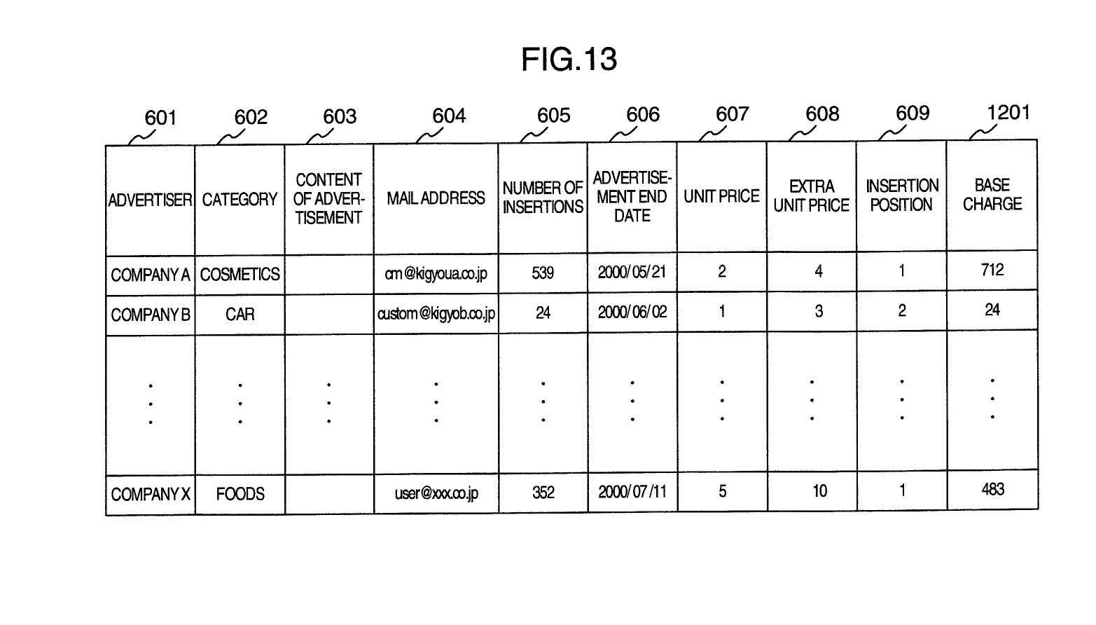

The advertisement content 603 represents the content of the advertisement to be inserted into the electronic mails to the user. FIG. 11 and FIG. 12 show some examples.

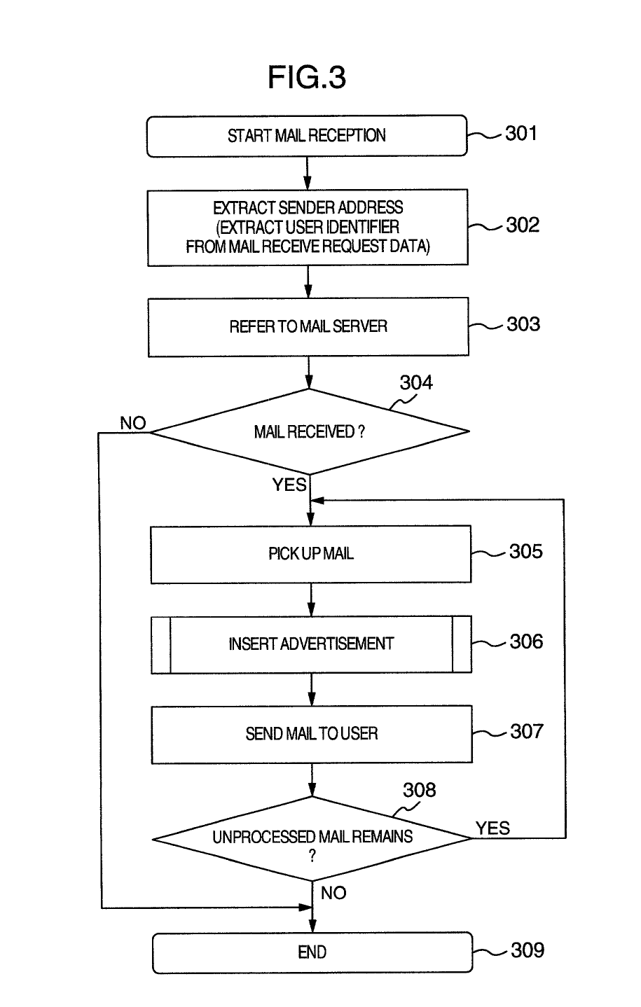

The electronic mail address 604 represents an e-mail address of the advertiser that can be used by the user to request an advertisement detail when the user cannot access the URL of the advertisement inserted in the e-mail, as when the user terminal is a cellular phone (the e-mail address may include other information such as address and telephone number for the user to contact the advertiser). Where an advertisement is inserted into an electronic mail to a cellular phone, the advertisement content 603 is changed so that a request mail can be sent to the electronic mail address 604 (i.e., the advertisement may be converted into a format of an electronic mail advertisement and attached with information such as electronic mail address of the advertiser. This processing is performed during the insertion of an advertisement in FIG. 3.) An example result of this processing is shown in FIG. 11. Here, at lines immediately preceding and following the advertising message a sequence of symbols “-” is added and each sentence of the message is displayed at a new line to make the message easy to read.

Another method may involve storing in the database advertisements having pictures, videos and voices added thereto according to the kind of terminal and, when the user clicks on an icon of advertisement, replacing the advertising message with appropriate video and voice to give advertising information to the user. In this way, the advertisement format can be changed into one that is easily handled and attracts attention of the user. Template data for converting the advertising message display into an appropriate one may be provided in the advertisement insertion unit so that the unit has a function of converting the advertisement display format according to the template designed for each terminal/advertisement category.

The information such as electronic mail address 604 stored in the database can be used by the ISP system operator to notify the advertiser of the amount charged.

The number of insertions 605 represents an accumulation counter indicating how many times the advertisement has been inserted into electronic mails. The advertiser can inquire the operator of the advertisement insertion server to know the total number of insertions. Checking the advertisement insertion number 605 and the corresponding category 602 provides an indication of which category of the products attracts attention of the users most. The value of the advertisement unit price 607 may be changed according to a change in the value of the advertisement insertion number 605. Such a function may be provided in the charge processing unit 208.

The advertisement end date 606 represents a period in which the advertisement insertion is continued. After this date, the advertisement in question is no longer inserted. The advertisement whose term has expired may be deleted. Setting a time limit for the advertisement is effective in providing products and services that are available only in a limited period of time. That is, a time limit can be set to prevent the advertisement insertion server 103 from sending an old advertisement that has already expired to the user terminals 106-108. The advertiser on the other hand can issue advertisements on seasonal goods in appropriate periods, which helps reduce expenses of advertisement and eliminate inappropriate content of advertisement.

The unit price 607 for each access represents an amount of money that is returned to the user each time he or she accesses a detailed advertisement presented in the current advertisement by clicking on a site when the detailed advertisement is described in URL or by sending a mail to an address when that mail address is provided. This value is determined by the advertiser and stored in the database.

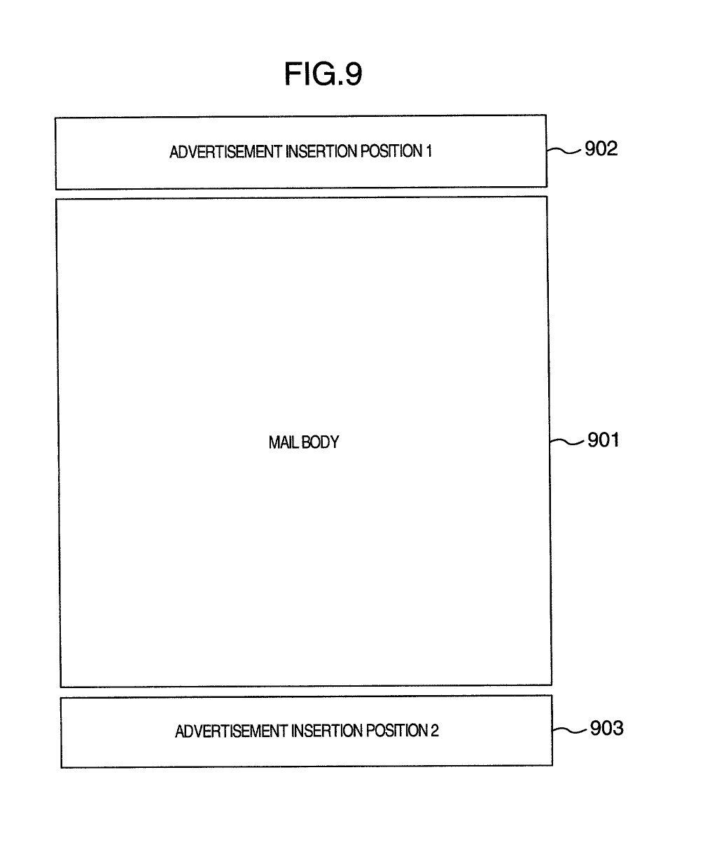

The extra unit price 608 is a unit amount to be refunded for each access which is used when the user makes frequent accesses (i.e., access frequency is high). (Here, the accesses are determined as being frequent when the time taken from one access to the next is shorter than a predetermined reference time duration stored in the database. In the case of a cosmetic product, for example, if the next access is made within two hours of the first access, the user may be determined as having made frequent accesses. In the case of goods which may take the customer a relatively long period of time for consideration, such as real estates, a period of two weeks may be set as a reference for the decision of frequent access. In this way different access intervals may be set for different goods as references for determining whether frequent accesses were made.) Here it is assumed that the user has made frequent accesses to the advertisement, increasing the value of advertisement, so that the user can receive a higher advertisement charge 608 than the unit price 607 for each access. (That is, the extra unit price 608 may be determined depending on the access frequency and the advertisement insertion number 605.) The advertiser may set the extra unit price 608 higher than the unit price 607 for each access. (It is noted here that the advertiser may give some refund to the user when he or she purchases the goods even if the access number and frequency are low.) The insertion position 609 specifies whether the advertisement is to be inserted on the front side 902 or rear side 903 of the body of the mail 901 of FIG. 9. When the advertisement is inserted before the body of the mail, it is highly likely that the user will take a look at the advertisement. So, the basic price for insertion at the front is set higher than at the rear. The value specified for the front is 1 and the rear 2.

The access decision interval 610 is a value used to determine whether frequent accesses have been made to a particular advertisement. The time interval from the last access date & time 705 to the next access time is compared with the value of the reference access interval 610 shown in FIG. 6. If the time interval from the last access date & time 705 to the next access time is smaller than the value of the reference access interval 610, it is decided that the advertisement has been frequently accessed and thus the charge processing unit 208 in the advertisement insertion server 103 adds the extra unit price 608 to the advertisement charge of the user who was determined to have made frequent accesses.

That is, the value of the reference access interval 610 is used to check whether frequent accesses were made to the advertisement and to calculate the amount to be refunded to the user as the advertisement charge. At 610 of FIG. 6 an example of reference access interval data that is stored in the database is shown in the form of “day:hour:minute”. This data may take any other form as long as it allows the access frequency to be determined. For example, rather than comparing the last access date & time 705 and the next access time, it may be possible to store a predetermined period in the database by specifying a start date and an end date (e.g., in the case of period from Dec. 20, 2000 to Dec. 25, 2000, the start date may be set as 20001220 and the end date as 20001225 in the database) and to count the number of accesses made during that period and determine the amount of money to be refunded to the user according to the number of accesses made in that period.

Addition of a record into the advertiser information database 212 is made when the advertiser registers with the advertisement insertion server 103 from the advertiser terminal 101 and when the advertiser changes the information in the advertiser information database 212.

The data registration unit 205, based on the information from the advertiser terminal 101, sets data in the advertiser information database 212 via the database access unit 209. At this time, the number of insertions 605 is set to 0.

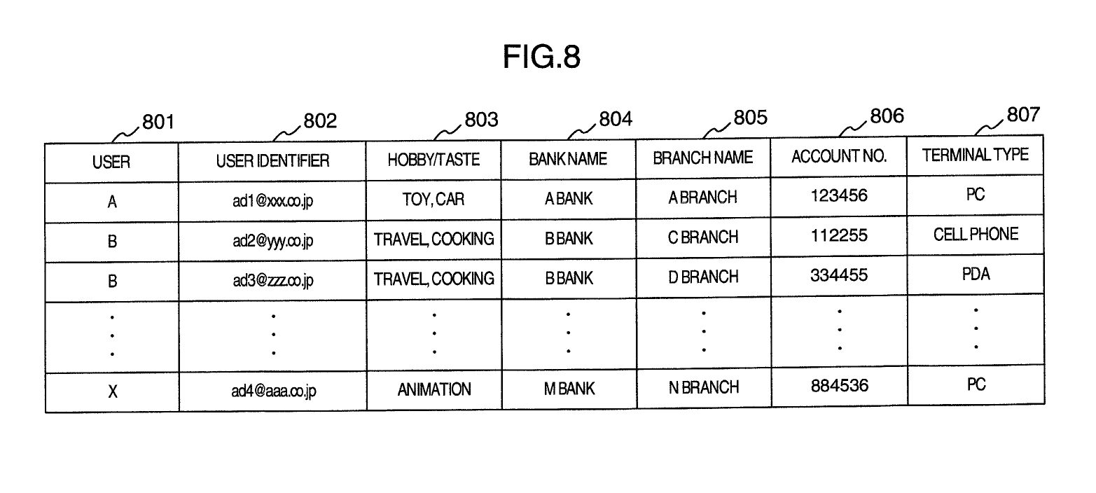

The personal information database 210 is shown in FIG. 8. The personal information database 210 is an aggregate of records each consisting of user name 801, user identifier 802, hobby/taste 803, bank name 804, branch name 805, account number 806, and terminal type 807.

The user name 801 represents the name of a person using the user terminal 106.

The user identifier 802 identifies the user when he or she accesses a URL contained in the advertisement at which details of the advertisement are presented. Here, the user identifier is set with an electronic mail address of the user.

The hobby/taste 803 signifies a field of advertisements in which the user is interested. Two or more fields may be specified. Only the advertisements whose category 602 matches this hobby/taste are inserted in electronic mails received by the user. Hence, the chances are small that unwanted advertisements may be received.

The bank name 804 represents the name of a bank in which to receive the money refunded by the advertiser for referring to the advertisement inserted in the electronic mail.

The branch name 805 is the name of a branch where the user has an account.

The account number 806 is an account number of the user.

The advertisement insertion server 103 receives the payment of the advertisement charge in a lump sum from the advertiser and then pays the advertisement charge into the account of each user. (Based on the advertisement charge and the amount to be refunded to the user calculated by the advertisement insertion server 103, the advertiser deposits the advertisement charge into a bank account of a company that runs the advertisement insertion server 103, from which the refunded money is deposited into the account of the user.)

The terminal type 807 represents the form of user terminal 106. Here, as an example, a cellular phone, a PDA (Personal Digital Assistant), and a PC (personal computer or terminal connected with a display) are used. Other forms of terminal may also be set.

When the user terminal has a small display and a small number of receivable characters and cannot access the WWW (World Wide Web) from electronic mails, the user terminal is set as “cellular phone”. (The registration of the terminal as a cellular phone is done by the user sending necessary data from the user terminals 106-108 to the advertisement insertion server 103 and by the advertisement insertion server 103 receiving the data from the user terminal and storing it in the personal information database 210.) When the user terminal has a relatively larger display than the cellular phone and a large number of receivable characters and also can access the WWW, it is registered as a “PDA.” If the user terminal is of a PDA type but cannot access the WWW, it is registered as a “cellular phone.” Depending on the type of the terminal used, the number of advertisements inserted and the way the details of the advertisements are presented vary.

In using the advertisement insertion service, the user registers with the advertisement insertion server 103 from the user terminal 106 a variety of information necessary for the use of the mail transmission/reception and advertisement service (For the detail of information that the user sends, see items 801-807 in FIG. 8). As in the case of the advertiser information, the data registration unit 205 sets the information into the personal information database 210 through the database access unit 209.

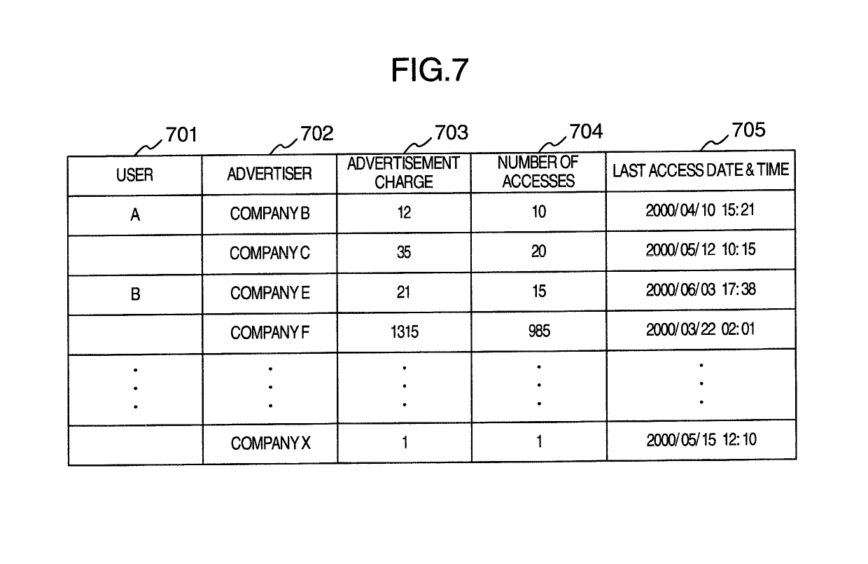

The access information database 211 is shown in FIG. 7. The access information database 211 manages accesses to advertisements that are inserted in electronic mails and is an aggregate of records each comprising user name 701, advertiser name 702, advertisement charge 703, number of accesses 704, and final access date & time 705.

The user name 701 is the name of a person who has accessed the detail of an advertisement. The content of this item is the same as the user name 801 in the personal information database 210.

The advertiser name 702 is the name of an advertiser of the advertisement that the user 701 has accessed. The content of this item is the same as the advertiser name 601 in the advertiser information database 212.

The advertisement charge 703 is the sum of an advertisement charge to be refunded to the user for the insertion of advertisement in the user's electronic mails and an amount of money received by the user for having accessed a site where a detailed advertisement is presented.

The number of accesses 704 indicates how many times the user have accessed the site where details of the advertisement are presented. A large value of this number is one indication that the user is interested in that advertisement.

The last access date & time 705 records the last date & time when the user made an access to the details of an advertisement. In addition to the number of accesses 704, this item is also used in determining whether the user is interested in the advertisement. It is decided that the user shows an interest in the advertisement when the access interval is short (frequent accesses have been made) even if the number of accesses is small. (That the access interval is short means that the time which elapses from the last access date & time to the next access is shorter than a predetermined time interval.) Next, the operation of the advertisement insertion server 103 will be explained.

FIG. 3 shows a flow of processing performed by the mail receiving unit 203.

In this system an electronic mail receive request made by the user is accepted by the mail receiving unit 203. The user terminals 106-108 that use the advertisement insertion server 103 sets the host information in the server 103 in advance so that the mail will be routed through the mail receiving unit 203 of the server 103. The mail send and receive requests conform to the standard rule for the mail transmission and reception such as SMTP (Simple Mail Transfer Protocol) and POP3 (Post Office Protocol version 3).

When an electronic mail reception inquiry enters the mail receiving unit 203, the mail receiving unit 203 extracts an electronic mail address of the user from the inquiry request data (Alternatively, the mail receiving unit 203 may receive the mail receive request data from the user terminal and extract a user ID from the mail receive request data) (step 302). (When an advertisement is inserted at step 306, the user database is searched by using the user electronic mail address extracted at step 302 as a key to extract from the database information necessary for the insertion of an advertisement.) An electronic mail reception inquiry is made to the mail server 110 (step 303). The data necessary for an inquiry to the mail server 110 (user ID, password and address of mail server 110) is either registered from the user terminals 106-108 with the advertisement insertion server 103 in advance by the users, or sent from the user terminals 106-108 to the advertisement insertion server 103 when making a mail reception inquiry. When it is found, as a result of the inquiry to the mail server 110, that the mail server 110 has no received mails addressed to the user who made the electronic mail reception inquiry (step 304), the mail reception processing is ended (step 309).

When mails are found, the mail receiving unit 203 receives one mail from the mail server 110 (step 305) and the advertisement insertion unit 204 inserts an advertisement in the received mail (step 306). After the advertisement is inserted, the mail is forwarded to the user terminal 106 (step 307). Then, an inquiry is made to the mail server 110 to see if there are unprocessed mails (i.e., to check whether the mail server 110 still has mails that are addressed to the user who have made the electronic mail reception inquiry) (step 308). If there are unprocessed mails, the sequence of steps beginning with 305 is repeated. When there are no unprocessed mails (step 308), the advertisement insertion processing is exited (step 309). Here, an example method has been described which picks up one electronic mail addressed to the user at a time from the mail server 110 and adds an advertisement to the mail before sending it to the user. It is also possible to extract a plurality of mails en mass from the mail server 110 and attach an advertisement to them at one time.

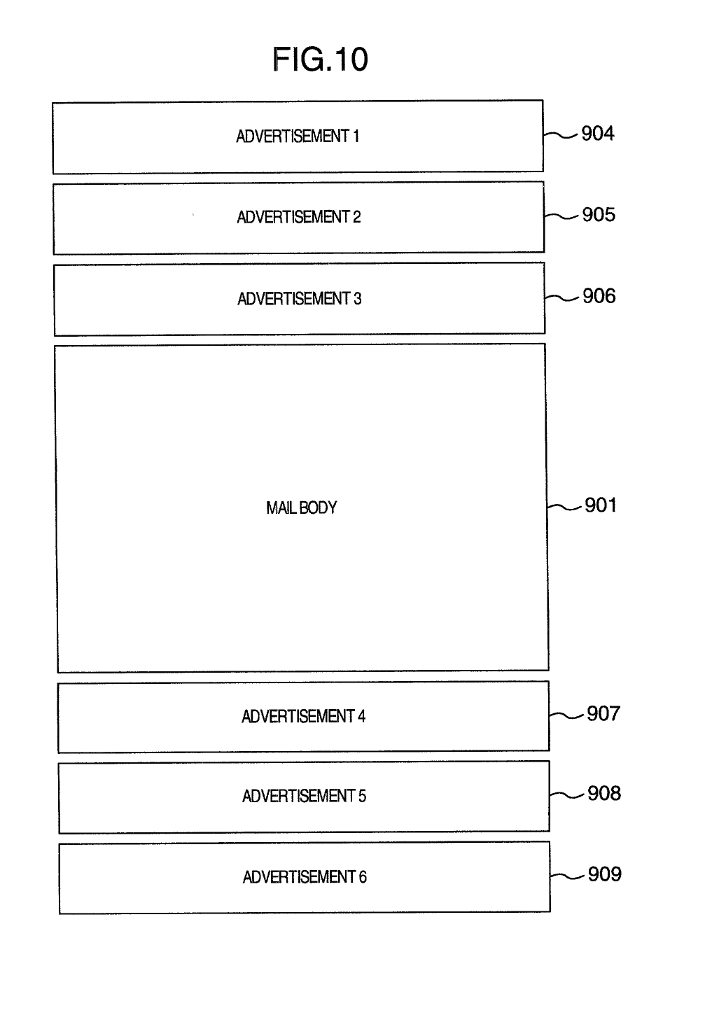

FIG. 9 and FIG. 10 show examples of how advertisements are inserted into an electronic mail received by the user. The locations and the number of inserted advertisements are modified according to the type of the terminal used.

When the user terminal is a cellular phone, an advertisement is inserted once at one position. This example is represented by a case of FIG. 9 with the advertisement inserted only at the insertion position 1 (902) before the body of the mail 901.

When the terminal is a PDA, the mail may have up to two insertion positions, each accommodating one advertisement. This example is represented by a case of FIG. 9 with the advertisements inserted both at the insertion position 1 (902) and the insertion position 2 (903). While this example assumes that the advertisements are inserted at two locations, if only fewer advertisements are available, the advertisement 1 or advertisement 2 may be omitted.

When the terminal is a PC, the mail may have two insertion positions, each accommodating three advertisements. This example is shown in FIG. 10, in which three advertisements (advertisement 1, advertisement 2, advertisement 3) are inserted at the insertion position 1 (902) and three advertisements (advertisement 4, advertisement 5, advertisement 6) are inserted at the insertion position 2 (903). As in the case of the PDA, when only fewer advertisements are available, some of these six advertisements may not be inserted.

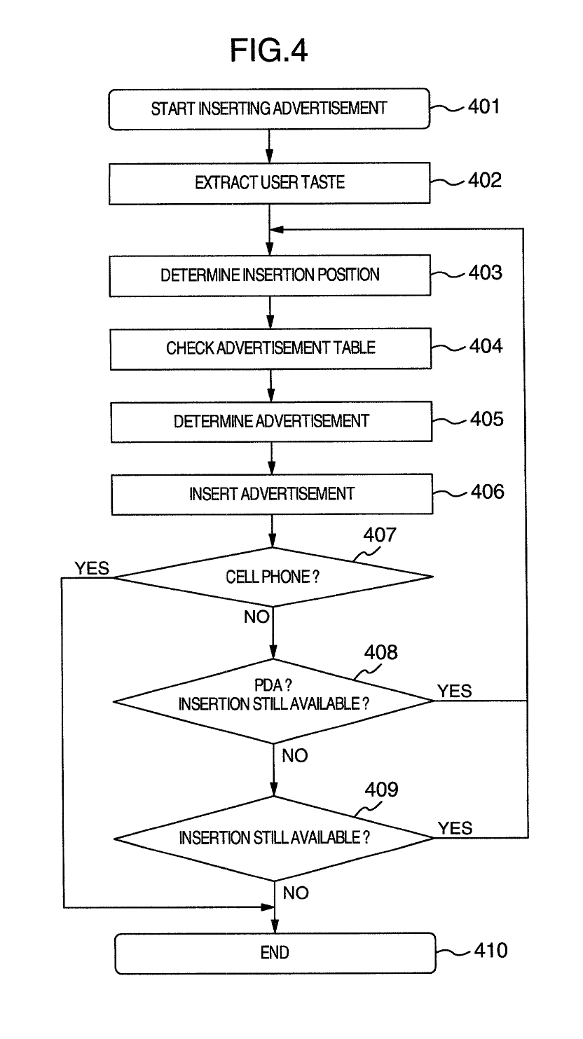

FIG. 4 shows the flow of advertisement insertion processing 306.

The advertisement insertion processing first picks up a taste of the electronic mail user from the hobby/taste 803 in the personal information database 210 (step 402). To insert a plurality of advertisements in an electronic mail, a loop counter is provided in the advertisement insertion processing (the processing from step 403 to step 409 is repeated the same number of times as the value of the loop counter). In insertion position determining processing 403 the insertion position in the current loop is determined by alternating the insertion position 1 (901) and the insertion position 2 (903) according to the type of user terminal and the value of the loop counter (alternation will be explained below). The type of the user terminal is retrieved from the terminal type 807 in the personal information database 211. For example, when the user terminal is a PC, the advertisement is inserted at the position 1 for up to the loop counter of 3 and, for the loop counter of 4 or higher, it is inserted at the position 2. When the user terminal is a PDA, the advertisement is inserted at the position 1 for the loop counter of 1 and at the position 2 for the loop counter of 2. Step 404 extracts from the advertiser information database 212 a plurality of advertisements that match the position determined by the step 403 and which has not passed the advertisement end date 606. Step 405 randomly determines an advertisement to be inserted from among the plurality of the extracted advertisements. (Alternatively, an advertisement to be inserted may be determined according to some rule. For example, the advertisements may be inserted successively in the descending order of the amount to be refunded to the user or in the order in which the information is stored in the advertiser information database). Step 406 inserts the advertisement at the determined position. When the advertisement is inserted, the count in the number of insertions 605 in the advertiser information database 212 is incremented by one. At the same time, the advertisement unit price stored in the advertisement insertion server is added to the advertisement charge 703 in the access information database 211 to determine the advertisement insertion charge. When the advertisement insertion server inserts an advertisement in an electronic mail to the user for the first time, it creates a record in the access information database 211. The user name 701 and the advertiser name 702 obtained by the mail receiving unit 203 and the step 405 are set in the record. The advertisement charge 703, the number of accesses 704 and the last access date & time 705 are cleared to 0.

Then, the advertisement insertion charge described above is calculated. When an access is made from a cellular phone, the processing is quickly exited because the advertisement is inserted only at one position. In the case of a PDA, because the advertisement is inserted at two positions, one above and one below the mail body, if the insertion is still available, the processing is returned to the insertion position determining processing 403 (step 408). In the case of a PC, the advertisement insertion is repeated until the number of inserted advertisements reaches a specified value (here six advertisements, for example) (step 409).

FIG. 11 shows examples of advertisements inserted in electronic mails when the user terminal is PC and PDA that can access URL.

The advertisement 1002 comprises a simple message as indicated in the advertisement content 603 in the advertiser information database 212 and a URL (Uniform Resource Locator) that can be accessed by the user with a Web browser.

The URL is generally described in the format of <scheme>:<scheme-specific-part>. Here, <scheme> designates an identifier representing the format and protocol in accessing information, which includes http (hypertext transfer protocol), ftp (file transfer protocol), telnet (communication with remote computers), wais (wide area information service), and file (access to files which the computer running the Web browser has locally). The <scheme-specific-part> has a different format depending on the kind of scheme.

When HTTP is used for <scheme>, the URL is generally described as http://<host>:<port>/<url-path>. (<host> denotes a domain name and host name or host address. <port> denotes a port number. The port number may be omitted. When it is omitted, a reserved 80th port is used. <url-path> is an HTTP selector which comprises a directory name and a file name separated by “/” and also a file identifier preceded by “.”.) While HTTP is used in the example embodiments, this invention can also be applied to other protocols than HTTP.

The advertisement insertion unit 204 generates information by adding the advertisement insertion server URL, the electronic mail user ID (802) and advertisement insertion position (609) data to a URL described in the advertisement content 603 where an actual detailed advertisement 1302 is displayed (referred to as a detailed advertisement URL). An example advertisement to which this generated information is added is shown at 1002 in FIG. 11. Here, information “advertisement insertion server URL?detailed advertisement URL?user ID?insertion position data” is attached. In FIG. 11, http://abc/srv represents the advertisement insertion server URL, http;//www.xxx.co.jp/yyy represents the detailed advertisement URL, ID=ad1@axxx.co.jp represents user information, and Pos=1 represents the advertisement insertion position data. When the detailed advertisement is not available, the description of URL is not necessary.

When the user terminal 106 accesses an advertisement URL inserted in an electronic mail (i.e., information “advertisement insertion server URL?detailed advertisement URL?user ID?insertion position data”), the Web access processing unit 207 in the advertisement insertion server 103 receives the user's URL access, rather than the URL access request going to the Web server 109 in the ISP system 102.

The Web access processing unit 207 extracts the user ID, the detailed advertisement URL and the insertion position from the URL sent from the user terminal 106, checks it against the URL of the advertisement content 603 in the advertiser information database 212, determines an advertiser from the matching record, and identifies a user who has the same user ID as the user identifier 802 in the personal information database 210. Then, the Web access processing unit 207 notifies the charge processing unit 208 of the advertiser name 601, user identifier 802 and advertisement information (insertion position 609), and also informs it that this is a URL access. After performing these processing in the advertisement insertion server, the Web access processing unit 207 accesses the Web server which then provides detailed advertisement information described in the advertisement URL and displays the detailed advertisement 1302 on the user terminal.

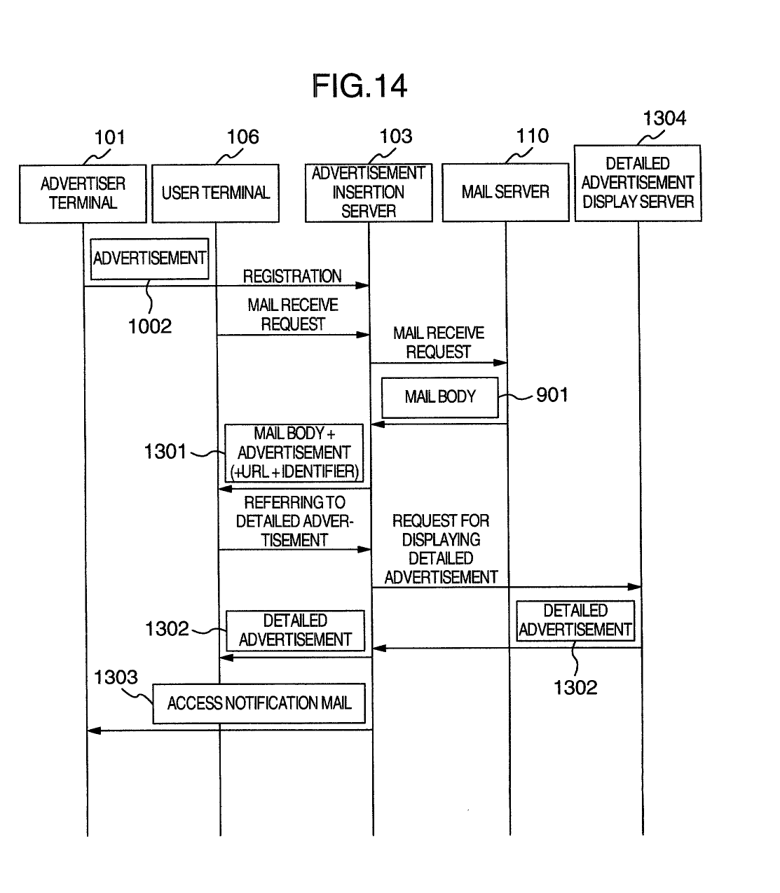

That is, using a mouse, the user clicks on the information “advertisement insertion server URL?detailed advertisement URL?user ID?insertion position data” (i.e., accesses the information described above) displayed on the user terminal by software such as browser or mail client of the user terminal 106. The browser function of the user terminal 106 accepts this input and accesses the advertisement insertion server 103 based on the information contained in the advertisement insertion server URL (host information and others are included in the URL as described above). The advertisement insertion server 103 receives the information “advertisement insertion server URL?detailed advertisement URL?user ID?insertion position data”, extracts the detailed advertisement URL, user ID and insertion position data from this information and, based on the information contained in the detailed advertisement URL, transfers the access request made by the user to a detailed advertisement display server 1304. The flow of these processing is shown in FIG. 14.

As described above, various processing, such as inserting data with an identifier-added URL into the advertisement and mail, transmitting the advertisement and mail to the user terminal, and receiving the data with the identifier-added URL and extracting the URL and the identifier, are performed by the advertisement insertion server 103 to allow the user to access the advertisement by performing the same operation as before. From the standpoint of the advertiser (or ISP side), because the advertisement insertion server 103 extracts the URL and the identifier, there is no need for the advertiser terminal to identify the user who has accessed the advertisement. Further, since the advertisement insertion server 103 collects and manages information on users, it is possible for the advertiser to obtain information on the advertisement users by using almost the same system operation as the conventional one.

While FIG. 11 at 1002 shows “advertisement insertion server URL?detailed advertisement URL?user ID?insertion position data” as an example of the identifier-added URL, it is possible to add the identifier to the URL by some other method and collect and manage the user information and advertisement information. This invention can also be applied to other than HTTP.

FIG. 12 shows an example of advertisement that is inserted in an electronic mail when it is received by a cellular phone. Since the cellular phone cannot handle the URL of the advertisement (here it is assumed that the terminal cannot access the information presented in the form of URL; if the terminal can access a URL, the same processing as in the case of PC and PDA may be performed), it sends an electronic mail to an electronic mail address which can send back a return mail carrying the advertisement. The advertiser information database 212 is registered with the advertisement content 603 intended for URL access. When an advertisement is to be inserted into a mail for the cellular phone, the electronic mail address 604 for advertisement access is inserted in the mail by changing the advertisement content 603.

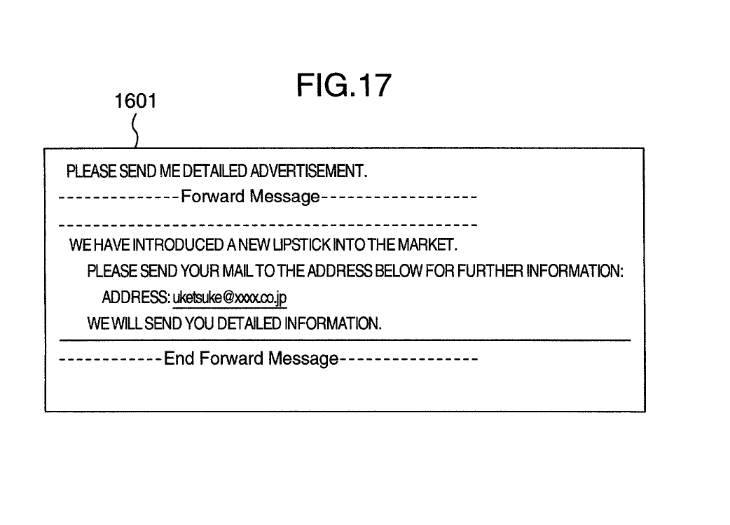

When the user requests a detailed advertisement electronic mail from an advertiser, the advertisement content is sent as is to the destination mail address 604 of the detailed advertisement (FIG. 17). In that case, the electronic mail is not sent directly to the mail server 110 of the ISP system 102 but is first received by the electronic mail sending unit 206. The electronic mail sending unit 206 checks the destination mail address to determine the electronic mail address 604 in the advertiser information database 212 and therefore the advertiser, compares the content of the mail body with the advertisement content 603 and, when they agree, decides that the mail is calling for a detailed advertisement. The electronic mail sending unit 206 also checks the sender address to determine the user identifier 802 in the personal information database 210 and therefore the user. Then, the electronic mail sending unit 206 notifies the charge processing unit 208 of the advertiser name 601, user identifier 802 and insertion position 609 and that this is an electronic mail access. After this, the electronic mail from the user requesting the detailed advertisement is forwarded to the mail server 110.

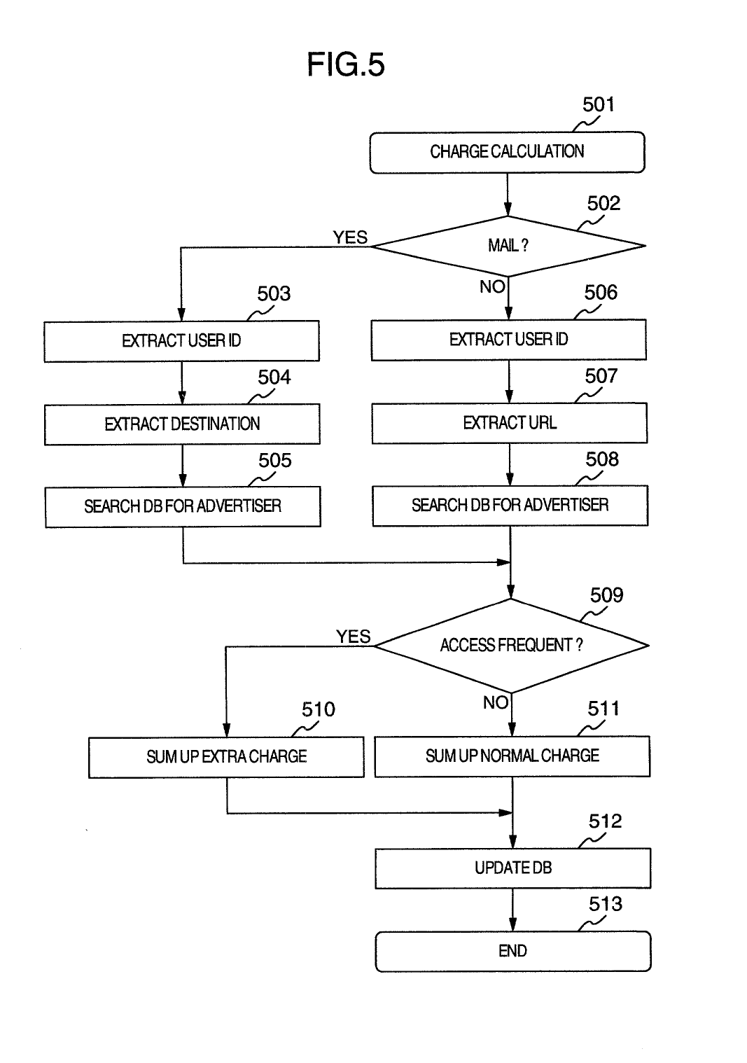

The charge processing unit 208 calculates the amount of money 607 to be returned to the user and the amount which the advertiser shall pay to the management company of the advertisement insertion server 103 and to the ISP system operator by using the values stored in the personal information database 210, the access information database 211 and the advertiser information database 212. The amount to be returned to the user may vary depending on the advertisement insertion position. When the advertisement insertion position is on the front side of the electronic mail body, the user surely sees the advertisement. When the advertisement is inserted on the rear side, however, the user may not see it. Hence, the charge for an advertisement inserted at the head of the mail is n times that of an advertisement inserted at the last position. The unit price 607 in FIG. 6 represents the charge for an advertisement inserted at the last position. (The advertisement charge may be determined according to the location of advertisement insertion. For example, an arrangement may be made in which, when an advertisement is inserted at the center, a large amount of money shall be paid to the user account from the advertiser account.) FIG. 5 shows a flow of the charge processing unit 208.

Step 502 checks whether the detailed advertisement request has been made by a URL access or by an electronic mail access. When the request is made by an electronic mail access, the subsequent processing extracts from the requesting electronic mail the user ID (electronic mail address) (step 503) and the destination (advertisement mail address) (step 504) and matches the extracted advertisement mail address against the electronic mail address 604 in the advertiser information database 212 to identify the advertiser.

When the step 502 decides that the request was made by a URL access, the user ID embedded in the detailed advertisement URL set from the user terminal 106 is extracted (step 506) and isolated from the detailed advertisement URL (step 507). This URL is checked against the URL in the advertisement content 603 in the advertiser information database 212 to determine the advertiser.

Based on this information, the number of accesses 704 and the last access date & time 705 in the access information database 211 are checked to determine whether the advertisement has been accessed frequently (step 509). If it is found that frequent accesses have been made, the extra unit price 608 is used to add an extra amount of money to the advertisement charge 703 (step 510). When the number of accesses is large or the access interval is short, it is decided that the user is interested in that advertisement. When the access is not frequent, the ordinary charge is applied (step 511).

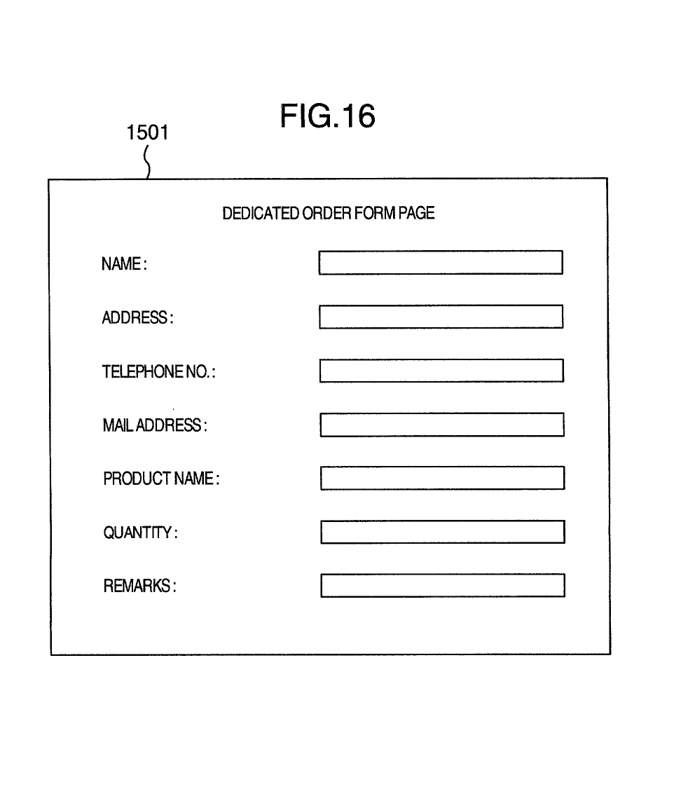

Step 512 increments the number of accesses 704 by one and writes an updated advertisement charge into the advertisement charge 703 column. It also records in the last access date & time 705 the date and time when the access was made, after which the processing of the charge processing unit is terminated. When a user makes a contract with the advertiser to buy a product in addition to accessing the URL or sending a detailed advertisement request electronic mail, a further amount of refund is added. The contract is made by an order/payment procedure on the WWW form in the detailed advertisement. For easy identification that the order was made through advertisement, a dedicated order form is used (FIG. 16). In the case of a terminal that can only handle an electronic mail, the content of an order is sent to the electronic mail address 604. The additional amount to be returned to the user because of the purchase made is notified by the advertiser terminal 101 to the operator of the advertisement insertion server 103 so that the operator can add the additional advertisement charge resulting from the contract to the advertisement charge 703 in the access information database 211 or that the same amount can be subtracted from the service charge paid by the user.

The amount to be returned to the user for advertisement accesses is charged once a month or so to the advertiser 101.

First, the base charge for inserting an advertisement is calculated.

Since the number of insertions 605 is recorded in the advertiser information database 212, this value is multiplied by the unit price determined by the operator of the advertisement insertion server 103 to obtain the base charge. The base charge is added to the amount of refund, and the total is charged to the advertiser 101. The base charge may be differentiated just as the amount of refund due to advertisement inquiry is differentiated depending on the position of advertisement insertion. In that case, as shown in FIG. 12, an item of base charge 1201 is added in the advertiser information database 212 and, when incrementing the number of insertions 605, the unit price per insertion multiplied by a correction factor based on the insertion position is added to the base charge. The correction factor is a ratio of the advertisement charge for an advertisement inserted before the body of an electronic mail to the advertisement charge for an advertisement inserted after it.

Further, the refunds are totaled for each advertiser. The total refund is calculated by summing the advertisement charges 703 of those records whose advertiser names in the advertiser name 702 column in the access information database 211 are same.

The sum of the base charge and the refund is what should be charged to the advertiser.

The advertisement insertion operator charges the amount described above to the electronic mail address 604 of the advertiser and at the same time informs the advertiser of the number of insertions 605 and the number of accesses 704 made in that month. The advertiser, upon receiving the bill, pays the amount charged into a specified account of the advertisement insertion operator. At the same time that the bill is sent, the advertisement refund is paid to the user.

When the amount charged is paid by the advertiser, the value in the advertisement charge 703 for the associated advertiser and the number of insertions 605 are cleared to zero.

A rough flow of operation when the user terminal is a PDA or PC is shown in FIG. 14.

When the electronic mail user terminal 106 receives an electronic mail from the mail server 110 through the advertisement insertion server 103, the mail received is an advertisement-added electronic mail 1301 which is a combination of an advertisement 1101 registered with the advertisement insertion server 103 by the advertiser terminal 101 and a mail body 901 received from the mail server 110.

When the user refers to information (URL +identifier), which is indicated in the advertisement 1301 inserted in the electronic mail and represents the detailed advertisement, the advertisement insertion server 103 checks the URL and the identifier and issues a detailed advertisement display request to the detailed advertisement display server 1304 which in turn displays the detailed advertisement 1302 on the WWW prepared by the advertiser. The advertisement insertion server 103, based on the identifier, accesses the personal information database 210, the access information database 211 and the advertiser information database 212, calculates the service charge and advertisement charge by the charge processing unit 208 and, as required, asks the advertiser to make the payment. Then, according to the amount to be paid calculated by the charge processing unit 208 in the advertisement insertion server and the information contained in the databases 210-212 accessed by the advertisement insertion server, the advertiser pays the advertisement charge to the operator of the ISP system 102 and a part of the advertisement charge is refunded to the user.

It is also possible to inform the advertiser when the user accesses a URL referring to a detailed advertisement. Because the Web access processing unit 207 identifies the advertiser name and the user ID (user electronic mail address), the electronic mail address of the user can be notified to the advertiser in the form of an access notification mail 1303 through the electronic mail sending unit 206. This is useful for the advertiser because the advertiser can know how often the advertisement is being accessed and issue a direct mail to the electronic mail address thus obtained.

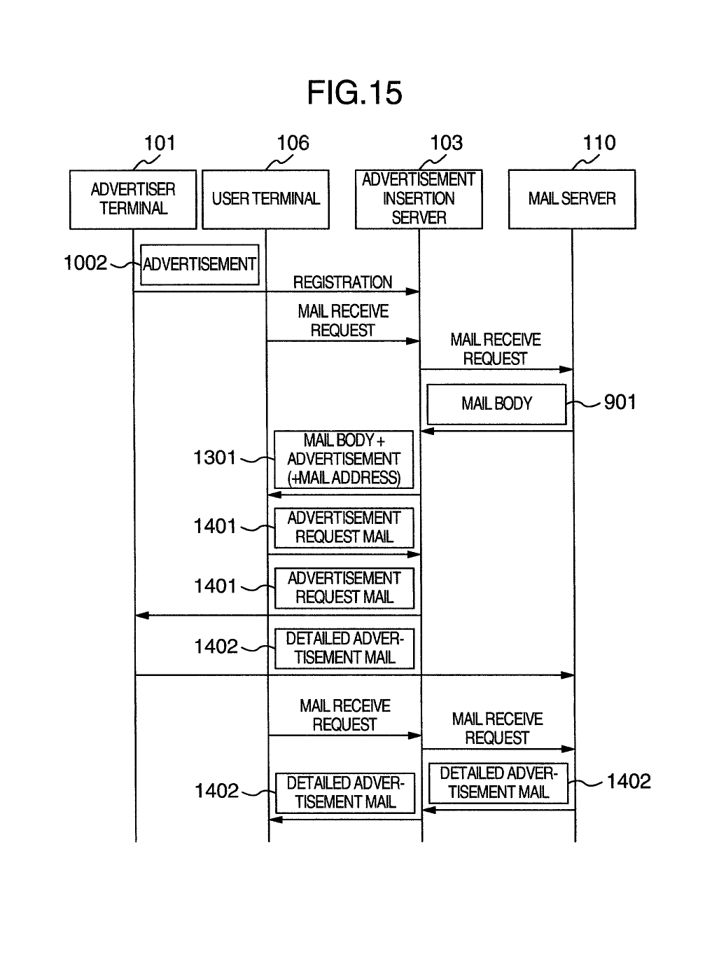

A rough flow of operation when the user terminal is a cellular phone is shown in FIG. 15.

The basic flow is similar to that of the PDA and PC (FIG. 14), except that the URL access for the detailed advertisement is replaced with an electronic mail access. When the user wishes to refer to the detailed advertisement, the user forwards the advertisement content received to the detailed advertisement mail address 604 prepared by the advertiser (1401). The advertiser, in response to the received request mail, sends the detailed advertisement mail (1402) to the sender of the advertisement request mail 1401.

The advertisement insertion server may be operated independently. In that case, when the user terminal 106 using an electronic mail software picks up an electronic mail from the ISP system 102 where the user mail box is provided, it connects to the independent advertisement insertion operator server 103 in the same way as it connects to the ISP system 102. The mail receiving unit 203 in the independent advertisement insertion operator server accesses the mail box in the ISP system 102 based on the user ID and pass word received from the user. This same procedure is carried out also in the Web access where the advertiser server itself plays an intermediary role for the ISP system.

As described above, with this invention the advertisement insertion server 103, when seen from the user, has a function of a mail server (or various servers on the ISP side and a WWW server), so that the user can utilize the advertisement service with almost the same operation as when the user is connected to the conventional mail server or others. For the advertiser (or ISP side), since the advertisement insertion server 103 collects and manages the information on the advertisement insertion and on the user, the advertiser terminal (or a system on the ISP side) can obtain user information without having to newly introduce a user information collecting system.

As described above, the use of the advertisement insertion server 103 of this invention makes it possible to newly provide the user terminal and the advertiser terminal (or a system on the ISP side) with an advertisement service without significantly modifying the conventional system (and applications). While in the foregoing discussion we have shown an example case of ISP, the technique of the present invention may be applied to an organization that provides a variety of services, such as ASP (Application Service Provider).

A program describing all or part of the processing of each function block shown in FIG. 2 may be stored in a computer-readable recording medium (magnetic disk, optical disk, etc.). The program may then be installed on the computer (or a cellular phone terminal) and run. Or the terminal may access the recording medium via the network and download the program for operation.

Next, other embodiments will be described.

In this embodiment, the advertiser pays a total amount of money to be refunded to users into a bank account in a lump sum in advance and the advertisement insertion server distributes the deposited amount to the users who have accessed the advertisement. Although this may be realized in the system shown in FIG. 1, here we will explain about a system where the advertisement insertion server 103 and the mail server 110 are run by the same operator. The advertisement insertion server 103 and the mail server 110 may be configured as the same system or as separate systems.

Next, the overall operation of the system will be explained. The processing and configurations of units in the system that are different from those explained above will also be described.

First, the user opens an account with a bank to pay the service charge for the use of the ISP system equipped with a mail server. The operator of the advertisement insertion server also has a bank account.

Let us first explain about the registration procedure for the advertiser to provide an advertisement. To provide an advertisement, the advertiser pays a refund into the bank account of the advertisement insertion server operator by using a bank terminal (step 1701). The advertiser receives from the bank terminal a voucher verifying the payment of the refund into the advertisement insertion server operator's account (1702). The advertiser sends the voucher, the amount paid and the advertisement information to the advertisement insertion server 103 (1703). The advertisement insertion server 103 checks the authenticity of the voucher forwarded from the advertiser. When the voucher is validated, the advertisement insertion server registers the amount of refund and the advertisement information with the advertiser information database 212. Now, the registration procedure on the part of the advertiser is finished.

For the user to use the advertisement service, the user sends the user information to the advertisement insertion server 103, which then registers the user information with the personal information database 210.

Next, a sequence of operations performed when the user on the user terminal issues a mail forward request will be described.

Using the user terminal 106, the user issues an electronic mail forward request to the advertisement insertion server 103 (step 1704). Upon receiving the electronic mail forward request, the advertisement insertion server 103 refers to the mail server and receives a mail of the user from the mail server. When it receives the mail, the advertisement insertion server extracts an address of the mail creator described in the mail, matches it with the user who has issued the electronic mail forward request, and registers them with the access information database 211. The advertisement insertion server sends the advertisement, the detailed advertisement URL and the identifier together with the received mail to the user terminal 106 (1705). This is realized by, between the processing 301 and 302 shown in FIG. 3, extracting the address of the mail creator described in the mail, matching the extracted address to the user who has issued the electronic mail forward request and registering them with the access information database 211. In the address extraction process, the address of the sender described in the mail can be identified by searching for a character string following “From” and including “@”, both described at the header of the mail.

Next, we will explain about a sequence of operations performed when the user uses the detailed advertisement URL sent to the user terminal 106 to access the advertiser terminal. Although the detailed advertisement is received from the advertiser terminal in this case, it may be prepared in a separate terminal. When, using a pointing device such as mouse, the user picks “advertisement insertion server URL?detailed advertisement URL?user ID?” sent to the user terminal 106 and displayed on the screen of the terminal, the “detailed advertisement URL” and “user ID” are sent to the advertisement insertion server (1706). The advertisement insertion server 103 calculates the advertisement charge according the “user ID”. This calculation of the advertisement charge allocates the refund, which was paid by the advertiser to the bank account of the advertisement insertion server operator, to the amount of advertisement charge of the users who have accessed the detailed advertisement URL. Because the users expect to be allocated with the refund for accessing the detailed advertisement URL, (1) when no refund is left in the account of the advertisement insertion server operator, the operator is required to notify the users and the advertiser that no allocation of refund is available. Further, (2) if the mail creator and the mail recipient are the same person, there is a possibility of the refund being illicitly used, so that an arrangement should be made to prevent the refund from being allocated when the mail creator and the mail recipient are the same person. Further, (3) there may be a case where the advertiser wants the allocation of refund to be limited to a specified period of time, so that an arrangement should be made to prevent the refund from being allocated to a person who makes an access to the “detailed advertisement URL” after the available period.

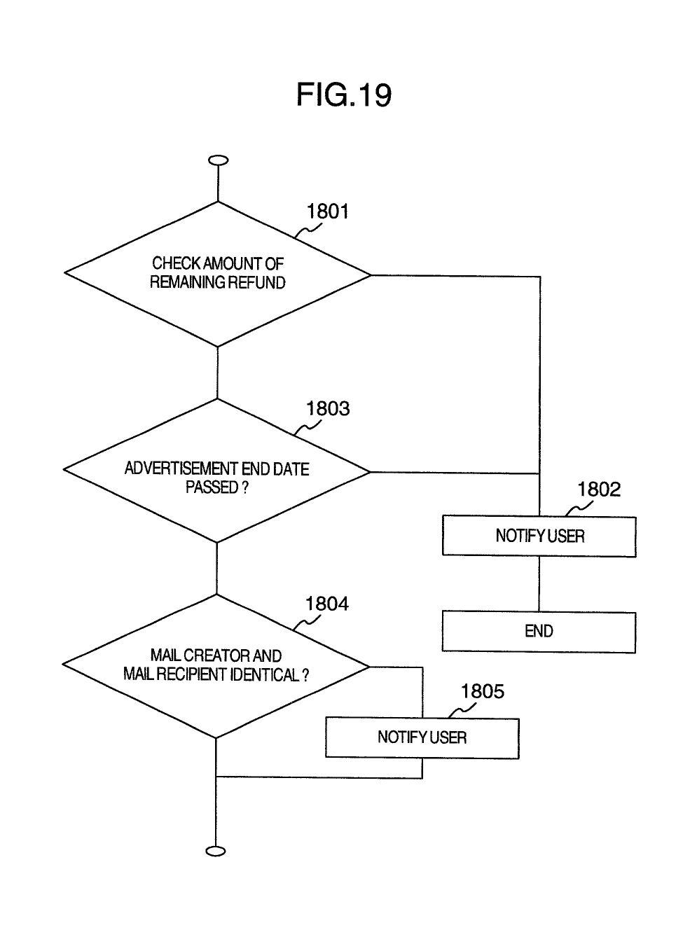

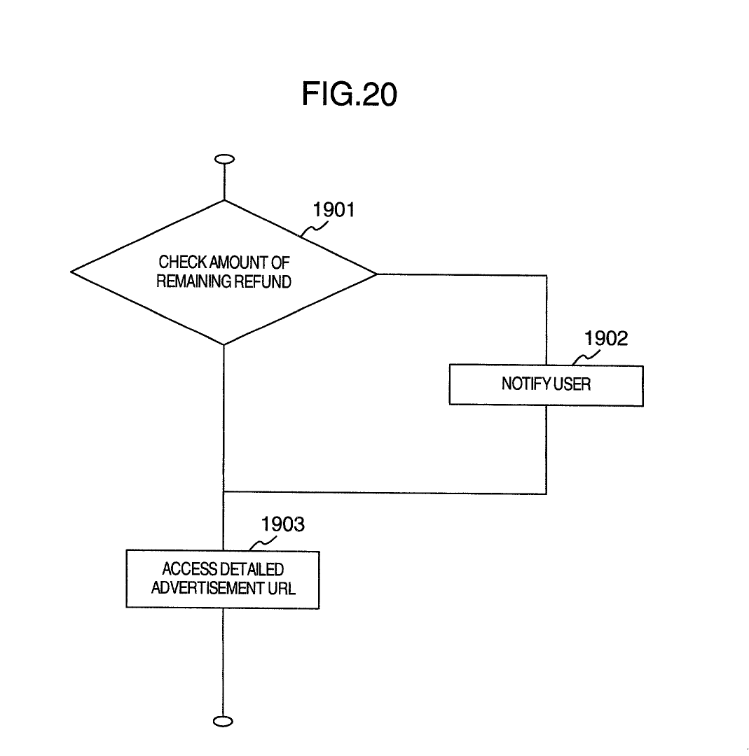

To perform the calculation of the advertisement charge in ways that meet the requirements (1) to (3), the processing shown in FIG. 19 and FIG. 20 are performed.

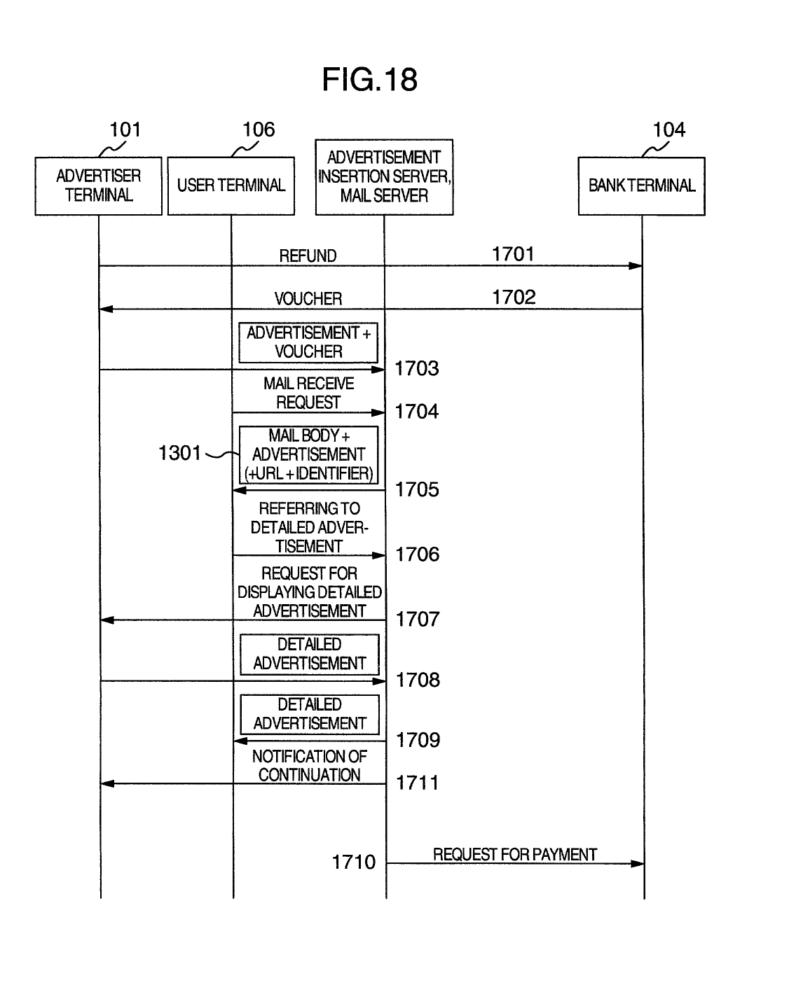

FIG. 19 shows processing executed between processing 507 and processing 508 in FIG. 5. First, a check is made as to whether the remaining refund is more than the amount of ordinary charge or extra charge (1801). When the amount of refund remaining is not sufficient, the users who are accessing the “detailed advertisement URL” are notified that the detailed advertisement URL cannot be accessed (1802), and the charge calculation processing is ended. At this time, the advertisement insertion server 103 does not access the detailed advertisement URL. If it is found that the sufficient amount of refund remains, the advertisement end date 606 is used to check whether the access to the detailed advertisement URL was made after the advertisement end date (1803). When the access was made after the advertisement end date, the user accessing the “detailed advertisement URL” is notified that the detailed advertisement URL cannot be accessed (1802), and the charge calculation processing is terminated. If the access is not past the advertisement end date, it is checked whether the user accessing the “detailed advertisement URL” and the mail creator are the same person (1804). When it is found that the mail creator and the person accessing the “detailed advertisement URL” are identical, the user accessing the “detailed advertisement URL” is informed that the allocation of the normal charge or extra charge is not available (1805). At this time, the advertisement insertion server 103 accesses the “detailed advertisement URL”. Although the processing 1803 solves the problem of (2) mentioned above, instead of the processing 1803, in the processing 1705 of FIG. 18, it may be done forwarding only the mail, the advertisement and the detailed advertisement URL, but not the identifier. In that case, the advertisement insertion processing (406) shown in FIG. 4 involves checking whether the mail creator registered in the access information database and a person requesting the dispatch of the mail are the same person and, when they are identical, inserting only the mail, the advertisement and the detailed advertisement URL and, when they are not, inserting the mail, the advertisement, the detailed advertisement URL and the identifier. With this arrangement, in the user ID (identifier) extraction processing (506) shown in FIG. 5, the user ID (identifier) is not extracted and thus the allocation of refund is prevented.

Next, FIG. 19 shows processing executed after the processing 512 in FIG. 5. It is checked whether the remaining refund is more than the amount of ordinary charge or extra charge (1901). When the amount of refund remaining is not sufficient, the advertiser is notified that the refund is lacking (1902). Next, an access is made to the extracted “detailed advertisement URL” (1903). Since the “detailed advertisement URL” is accessed in step 1903, the step 507 in this embodiment does not make an access to the “detailed advertisement URL”. In the extra charge summation and the normal charge summation in steps 510 and 511, the total of the extra charge and normal charge is subtracted from the refund and, at step 512, the amount of refund is updated.

The series of processing shown in FIG. 19, FIG. 20 and FIG. 5 is executed when the request made by the user for referring to the detailed advertisement is received. With these processing, the problems (1) to (3) described above can be solved. Having been informed that the refund is lacking, the advertiser deposits additional refund into the account of the advertisement insertion server operator (1702) and sends the voucher to the advertisement insertion server 103 so that the advertiser can continue providing the advertisement. Further, in steps 510 and 511 that allocate the refund, when a search finds that the mail creator is already registered in the personal information database 210, it is possible to allocate a part of the refund also to the mail creator.

The advertisement insertion server 103 periodically makes a request to the bank terminal for money transfer (1710). This payment request involves asking the bank terminal to transfer the normal charge and extra charge allocated to the user from the account of the operator to the account of the user. The advertisement insertion server sends to the bank terminal 104 the account number of the operator, the normal charge, the extra charge, and the account number of the user to which the advertisement charge should be transferred. The advertiser may transfer the refund that remains after the advertisement end date (the refund that remains unallocated to the normal charge and extra charge) to another account of the operator. When the advertisement insertion server and the mail server are run by separate operators, a part of the remaining refund may be transferred to an account of the mail server operator.

As described above, with this embodiment it is possible for the advertiser and the advertisement insertion server operator to provide an advertisement insertion system with an improved security.

In addition to the preceding embodiments, it is possible to describe the processing shown in FIG. 19 and FIG. 20 as a program, store the program in a computer-readable storage medium such as magnetic disks, optical disks and magnetooptical disks, and read the program from the storage medium and run it on the computer with a storage device to execute the processing.

With this invention, the electronic mail user can receive from the advertiser an advertisement charge, as a partial refund of the electronic mail service charge, for referring to advertisements inserted in electronic mails.

Further, when the user shows an interest in the inserted advertisement or purchases goods presented in the advertisement, the user can receive a greater amount of advertisement charge as a refund.

For the electronic mail user, this system allows for the use of the Internet and electronic mail at a reduced service charge.

The advertisement insertion server can identify the user who refers to the detailed advertisement.

1. In a system having a plurality of terminals and a server for forwarding electronic mails to any of the terminals at the request of the terminal, an advertisement method using an electronic mail which the server sends an information about an advertisement to the electronic mail,
wherein, according to a request to send a electronic mail from a terminal, the server generates an information having an advertisement message, a URL related to the advertisement, a URL of the server and an identifier, and
forwards the generated information together with the electronic mail to the requesting terminal.

2. An advertisement method using an electronic mail of claim 1, wherein the identifier added to the URL is an information about the terminal that recognizes the identifier and an information about the user ID.

3. An advertisement method using an electronic mail of claim 2, wherein the terminal which received the information forwarded together with the electronic mail displays the information with the electronic mail on a screen, and
by specifying the displayed information, sends the advertisement-related URL and the identifier contained in the information to the server.

4. An advertisement method using an electronic mail of claim 3, wherein the server which received the advertisement-related URL and the identifier from the terminal accesses another terminal according to the URL, and identifies the terminal that sent the advertisement-related URL based on the identifier.

5. In a system having a plurality of terminals and a server for sending electronic mails to any of the terminals at the request of the terminal, an advertisement system using an electronic mail which the server sends an information about an advertisement to the electronic mail,
wherein the server comprises:
a unit for accepting a request to send an electronic mail from the terminal;
an information generating unit for generating an information having an advertisement message, a URL related to the advertisement, a URL of the server and an identifier; and
a unit for sending the generated information together with the electronic mail to the requesting terminal.

6. In a system having a plurality of terminals and a server for sending electronic mails to any of the terminals at the request of the terminal, a server program realizing an advertisement method using an electronic mail which the server sends an information about an advertisement to the electronic mail,
wherein the server program generates an information having an advertisement message, a URL related to the advertisement, a URL of the server and an identifier, and
sends the generated information together with the electronic mail to the requesting terminal.

7. An advertisement method using an electronic mail in a system in which a user terminal, a server, a database, a mail server and an advertiser terminal are connected to a network, wherein the advertisement method using an electronic mail comprising the steps of:
holding in the database an user-related information sent from the user terminal and an advertisement-related information sent from the advertiser terminal;
accepting an electronic mail receive request data sent from the user terminal by the server and extracting a user identifier from the receive request data;
based on the electronic mail receive request, inquiring to the mail server by the server whether the mail server has received any electronic mail addressed to the user terminal,
if the inquiry finds that there is an electronic mail addressed to the user terminal, receiving the electronic mail by the server;
based on the extracted user identifier, searching through the user-related information and the advertisement-related information stored in the database;
based on a result of the search, inserting an advertisement and information into the electronic mail received by the server, adjecting an identifier to a URL for referring to the advertisement information; and
sending the electronic mail attached with the advertisement information to the user terminal.

8. An advertisement method using an electronic mail of claim 7, wherein in the step of inserting the advertisement into the electronic mail being received by the user terminal,
the server calculates an amount of money to be refunded to the user according to a location where the advertisement is inserted, and
sends a result of the calculation to the advertiser terminal.

9. An advertisement system using an electronic mail in which a user terminal, a server, a database, a mail server and an advertiser terminal are connected to a network,
wherein the advertisement system using an electronic mail comprises:
the database holding user-related information sent from the user terminal and advertisement-related information sent from the advertiser terminal;
and the server accepting an electronic mail receive request data sent from the user terminal,
extracting a user identifier from the receive request data,
based on the extracted user identifier, searching through the user-related information and the advertisement-related information,
inserting an advertisement into an electronic mail to be sent to the user terminal according to a result of the search,
calculating an amount of money to be refunded to the user according to information on the advertisement insertion, and
sending to the advertiser terminal a calculated result of the amount of money to be refunded to the user.

10. In a system having a user terminal for sending and receiving an electronic mail, an advertiser terminal for providing an advertisement, and a server for forwarding an electronic mail to the user terminal at the request of the user terminal, an advertisement method using an electronic mail for sending by the server an electronic mail and advertisement-related information to the user terminal,
wherein the server holds an amount of money to be refunded which is provided in advance by an advertiser,
when receiving from the user terminal an information for identifying the advertiser terminal and an identification information for identifying the user, the server identifies the user corresponding to the identification information by user informations matched to the identification information in advance and allocates to the user a part of the amount of money to be refunded.

11. An advertisement method using an electronic mail of claim 10, wherein the server accesses the advertiser terminal based on the advertiser terminal identification information and sends the advertisement provided by the advertiser terminal to the user terminal to which a part of the amount of money to be refunded was able to be allocated.

12. An advertisement method using an electronic mail of claim 11, wherein, in the process of sending an electronic mail to the user terminal, the server extracts a creator of the electronic mail, matches it with the user and holds them, and
after receiving from the user terminal information for identifying the advertiser terminal and identification information for identifying the user, the server does not allocate to the user a part of the amount of money to be refunded when the creator of the electronic mail and the user are identical.
